(19) United States
(12) Patent Application Publication
(10) Pub. No.: US 2015/0249400 A1
(43) Pub. Date: Sep. 3, 2015

(54) CONVERTER

(71) Applicant: ABB Technology AG, Zurich (CH)

(72) Inventors: Adrian ZUCKERBERGER, Untersiggenthal (CH); Jonas FRITSCHY, Brugg (CH)

(73) Assignee: ABB TECHNOLOGY AG, Zurich (CH)

(21) Appl. No.: 14/712,706

(22) Filed: May 14, 2015

Related U.S. Application Data
(63) Continuation of application No. PCT/EP2013/073743, filed on Nov. 13, 2013.

(30) Foreign Application Priority Data
Nov. 16, 2012 (EP) 12192990.5

(51) Int. Cl. H02M 5/44

(52) U.S. Cl. CPC H02M 5/44

(57) ABSTRACT

A converter includes a DC link and at least one phase module that is electrically connected to the DC link and has a phase conductor (Lu) emerging from said phase module. The DC link has a positive potential connection (+V_{DC}), a negative potential connection (−V_{DC}), and a neutral point connection (NP). A first energy store is connected between the positive potential connection (+V_{DC}) and the neutral point connection (NP), and a second energy store is connected between the neutral point connection (NP) and the negative potential connection (−V_{DC}). The phase conductor (Lu) is connected to the positive potential connection (+V_{DC}) via a first diode and to the negative potential connection (−V_{DC}) via a second diode. An energy supply charges the first energy store and the second energy store. The energy supply is connected firstly to the neutral point connection (NP) and secondly to the phase conductor (Lu) via a switch.

### RELATED APPLICATION(S)

This application claims priority under 35 U.S.C. §119 to International application PCT/EP2013/073743 filed on Nov. 13, 2013, designating the U.S., and claiming priority to European application 12192990.5 filed on Nov. 16, 2012. The content of each prior application is hereby incorporated by reference in its entirety.

### FIELD

The present disclosure relates to the field of converters, in particular to converters having a DC link and at least one phase module.

### BACKGROUND INFORMATION

Converters having a DC link and an inverter include capacitors or energy stores contained in the DC link. The capacitors should be charged before the rectifier of the converter is connected to the supply grid in order that said capacitors or energy stores are not damaged. Otherwise, the capacitors in the DC link could be damaged or should be designed for such loading.

It has been demonstrated that the capacitors in the respective phase modules of the inverter should be charged carefully from their initially completely discharged state in order that they are not damaged during operation or do not call for a design for high initial loads.

### SUMMARY

An exemplary converter is disclosed comprising: a DC link and at least one phase module, which is electrically connected to the DC link and includes a phase conductor (Lu) emerging from said phase module, wherein the DC link has a positive potential connection (+V_{DC}), a negative potential connection (−V_{DC}), and a neutral point connection (NP), a first energy store is connected between the positive potential connection (+V_{DC}) and the neutral point connection (NP), and a second energy store is connected between the neutral point connection (NP) and the negative potential connection (−V_{DC}), wherein the phase conductor (Lu) is connected to the positive potential connection (+V_{DC}) via a first diode and to the negative potential connection (−V_{DC}) via a second diode, and wherein the converter has an energy supply for charging the first energy store and the second energy store, which energy supply is connected firstly to the neutral point connection (NP) and secondly to the phase conductor (Lu) via a switch.

### BRIEF DESCRIPTION OF THE DRAWINGS

The subject matter of the disclosure will be explained in more detail in the following text with reference to exemplary embodiments which are illustrated in the attached drawings, in which:

FIG. 1 shows a converter which is connected firstly to a supply grid and is connected secondly to a load, where an energy supply is connected to the converter in accordance with an exemplary embodiment of the present disclosure;

FIG. 2 shows a detail view of the converter shown in FIG. 1 in accordance with an exemplary embodiment of the present disclosure; and

FIG. 3 shows a phase module of the converter in accordance with an exemplary embodiment of the present disclosure.

### DETAILED DESCRIPTION

Exemplary embodiments of the present disclosure provide a converter and method for operating a converter which enables careful charging of the DC link.

In accordance with an exemplary embodiment of the present disclosure, the converter includes a DC link and at least one phase module, which is electrically connected to the DC link and includes a phase conductor emerging from said phase module, wherein the DC link (14) has a positive potential connection, a negative potential connection and a neutral point connection, and a first energy store is connected between the positive potential connection and the neutral point connection, and a second energy store is connected between the neutral point connection and the negative potential connection, wherein the phase conductor is connected to the positive potential connection via a first diode and to the negative potential connection via a second diode, and wherein the converter can have an energy supply for charging the first energy store and the second energy store, which energy supply is connected firstly to the neutral point connection and secondly to the phase conductor via a switch.

The exemplary converter according to the present disclosure therefore can have the energy supply, which is intended for charging the first energy store and the second energy store. The energy supply enables extremely simple charging of the first energy store and of the second energy store. In order to charge the first energy store and the second energy store, a rectifier therefore can be omitted.

In accordance with another exemplary embodiment of the present disclosure, the energy supply of the converter is formed by a transformer, wherein the transformer is single-phase on its secondary side and is connectable to a supply grid on its primary side.

The exemplary converter enables simple charging of the first energy store and the second energy store. Only the first diode and the second diode of the phase module are specified.

In accordance with an exemplary embodiment of the present disclosure, in a first circuit, the first energy store of the converter is connected in series with the energy supply via the neutral point connection, said energy supply is connected in series with the first diode via the phase conductor, and said first diode is connected in series with the positive potential connection. Furthermore, in a second circuit, the second energy store is connected in series with the second diode via the negative potential connection, and said second diode is connected in series with the energy supply via the phase conductor.

The exemplary converter described herein enables simple charging of the first energy store and the second energy store.

In accordance with another exemplary embodiment of the present disclosure, the first diode of the converter is formed by a bidirectional semiconductor switch having a controlled unidirectional current conduction direction, and/or the second diode is formed by a bidirectional semiconductor switch having a controlled unidirectional current conduction direction.

The exemplary converter as described herein enables a simple configuration of the disclosure in comparison with known converters, which often include bidirectional semiconductor switches having a controlled unidirectional current conduction direction. Apart from the energy supply, the exemplary converter of the present disclosure specifies no new elements.

In accordance with an exemplary embodiment of the present disclosure, the at least one phase module of the converter can have a further energy store, which is assigned to the phase module and is connected firstly to the neutral point connection via a second, bidirectional semiconductor switch having a controlled unidirectional current conduction direction and to the phase conductor via the first diode and is connected secondly to the neutral point connection via a first, bidirectional semiconductor switch having a controlled unidirectional current conduction direction and is connected to the phase conductor via the second diode.

Accordingly, the exemplary converter includes the energy supply, which enables simple charging of the further energy store of the phase module.

In accordance with another exemplary embodiment of the present disclosure, a further energy store of the converter, which is assigned to the phase module, in a third circuit is connected in series with the first, bidirectional semiconductor switch, the energy supply and the first diode, and, in a fourth circuit, the further energy store is connected in series with the second diode, the energy supply and the second, bidirectional semiconductor switch.

This exemplary circuit enables efficient charging of the further energy store by means of the energy supply.

According to exemplary embodiments of the present disclosure, the converter is operated by applying an AC voltage to the energy supply, closing the switch, charging the first energy store with a first half-cycle of the current of the energy supply, and charging the second energy store with a second half-cycle of the current of the energy supply, wherein the converter can have a DC link and a phase module, which is electrically connected to the DC link and includes a phase conductor emerging from said phase module, wherein the DC link can have at least a positive potential connection, a negative potential connection and a neutral point connection and can have a first energy store between the positive potential connection and the neutral point connection and a second energy store between the neutral point connection and the negative potential connection, wherein the phase conductor is connected to the positive potential connection via a first diode and to the negative potential connection via a second diode, and wherein the converter furthermore can have an energy supply, which is connectable firstly to the neutral point connection and secondly to the phase conductor via a switch.

In accordance with an exemplary embodiment of the present disclosure the converter provides simple charging of the first energy store and the second energy store by means of the energy supply.

In accordance with yet another exemplary embodiment of the present disclosure, the phase module can have a further energy store, which is associated with the phase module and is connected firstly to the phase conductor via the first diode and to the neutral point connection via a second semiconductor switch having a controlled unidirectional current conduction direction and is connected secondly to the phase conductor via the second diode and to the neutral point connection via a first semiconductor switch having a controlled unidirectional current conduction direction, wherein the method can have the following further steps, closing at least one of the first semiconductor switch and the second semiconductor switch, charging the further energy store associated with the phase module by means of the energy supply.

This exemplary embodiment enables simple charging of the further energy store of the phase module.

In accordance with another exemplary embodiment of the present disclosure, the further energy store associated with the phase module is charged parallel to the charging of the first energy store and the second energy store.

The exemplary methods disclosed herein enable quick as well as safe charging of the further energy store.

In accordance with an exemplary embodiment of the present disclosure, the first semiconductor switch and the second semiconductor switch are closed, and the further energy store associated with the phase module is charged by means of the positive and negative half-cycles of the energy supply.

The exemplary method of the present disclosure enables efficient charging of the further energy store by means of an AC voltage source, for example a transformer, which is connected to a low-voltage supply grid.

In accordance with yet another exemplary embodiment of the present disclosure, the at least one phase module is a first phase module, and the converter (10) can have a second phase module, wherein the second phase module can have a further energy store, which is associated with the second phase module and which is connected firstly to a further phase conductor via a first diode of the second phase module and to the positive potential connection via a second semiconductor switch having a controlled unidirectional current conduction direction of the second phase module and is connected secondly to the further phase conductor via a second diode of the second phase module and to the negative potential connection via a first semiconductor switch having a controlled unidirectional current conduction direction of the second phase module, wherein the method can have the following further steps, closing the first semiconductor switch of the second phase module and the second semiconductor switch of the second phase module, charging the further energy store associated with the second phase module by means of the first energy store and the second store of the DC link.

This method enables simple charging of a further energy store in a second phase module of the converter.

In accordance with an exemplary embodiment of the disclosure, the further energy store associated with the second phase module is charged parallel to the charging of the first energy store and the second energy store.

This exemplary method of the present disclosure enables quick and safe charging of the further energy store of the second phase module.

In accordance with an exemplary embodiment of the present disclosure, the method can have the following further steps, connecting the first phase conductor to the second phase conductor, opening the first semiconductor switch of the first phase module, opening the second semiconductor switch of the second phase module, closing the second semiconductor switch of the first phase module, closing the first semiconductor switch of the second phase module, charging the further energy store of the first phase module and the further energy store of the second phase module.

The exemplary method disclosed herein makes it possible to charge the further energy store of the first phase module and the further energy store of the second phase module by means of the DC link or to maintain the charge in the further energy store of the first phase module and the further energy store of the second phase module. For example, the DC link can be charged as described above or, if the charge in the DC link only should be maintained, this latter condition can be achieved via the rectifier of the converter.

Exemplary embodiments of the present disclosure are described by way of example with reference to the appended drawings. These exemplary embodiments of the disclosure do not represent restricted examples of the disclosure.

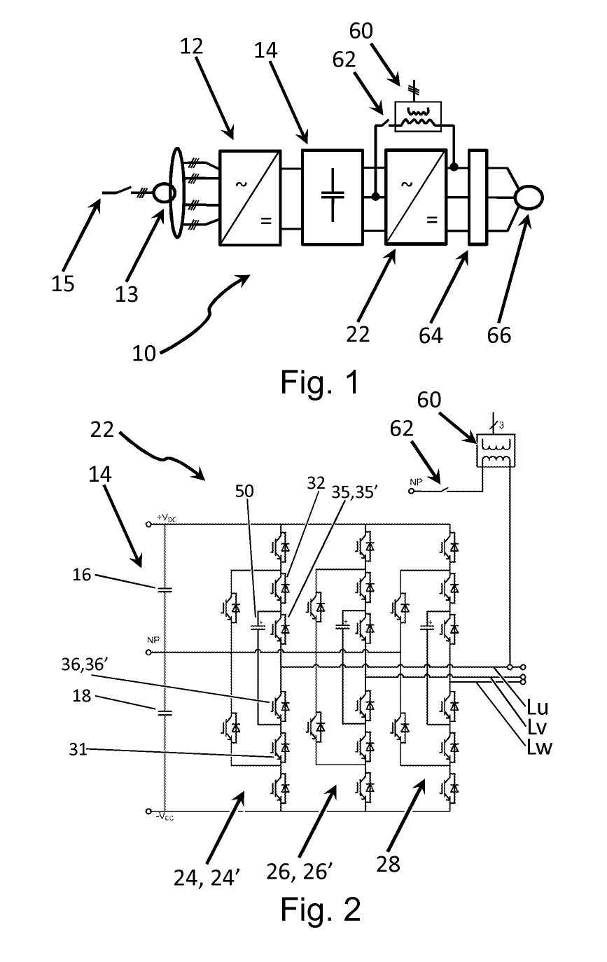

FIG. 1 shows a converter which is connected firstly to a supply grid and is connected secondly to a load, where an energy supply is connected to the converter in accordance with an exemplary embodiment of the present disclosure. FIG. 1 shows a converter 10, which can have a known rectifier 12 on the grid side, said rectifier 12 being in the form of a diode rectifier, for example. The rectifier 12 shown is in the form of a 24-pulse rectifier. Other embodiments are likewise possible. The rectifier 12 is connected to the supply grid 15 via a transformer 13 and a switch. The supply grid can be, for example, a medium-voltage supply grid and has, for example, a voltage of between 1 kV and 30 kV, and according to an exemplary embodiment between 5 kV and 10 kV and is three-phase. On the DC voltage side, the rectifier 12 is connected to a DC link 14.

FIG. 2 shows a detail view of the converter shown in FIG. 1 in accordance with an exemplary embodiment of the present disclosure. As shown in FIG. 1 and FIG. 2, the DC link 14 can have a positive potential connection +V_{DC} and a negative potential connection −V_{DC}. A first energy store 16 and a second energy store 18 are arranged in series with one another in the DC link 14 between the positive potential connection +V_{DC} and the negative potential connection −V_{DC}. The neutral point between the first energy store 16 and the second energy store 18 forms a neutral point connection NP.

Often the first energy store 16 and the second energy store 18 are each formed by a capacitor or by a plurality of capacitors.

An inverter 22 is connected to the DC link 14, said inverter being fed by the DC link 14. The inverter 22 shown is three-phase, but could also be two-phase or have more than three phases. For each phase u, v, w, the inverter 22 can have a phase module 24, 26, 28, which is connected on the input side to the DC link 14 and can have a phase conductor Lu, Lv, Lw on the output side, said phase conductor being connectable switchably at least to the positive potential connection +V_{DC}, the neutral point connection NP or the negative potential connection −V_{DC}.

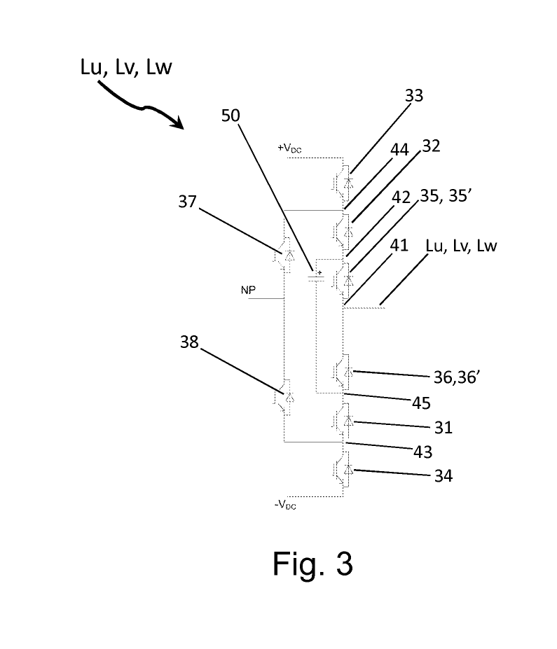

FIG. 3 shows a phase module of the converter in accordance with an exemplary embodiment of the present disclosure. As shown in detail in FIG. 3 and in FIG. 2, each phase module 24, 26, 28 can have six series-connected bidirectional semiconductor switches 31, 32, 33, 34, 35, 36 having a controlled unidirectional current conduction direction, which bidirectional semiconductor switches are therefore connected to one another at five star points 41, 42, 43, 44, 45.

The third semiconductor switch 33 is connected firstly to the positive voltage potential +V_{DC} and the fourth star point 44. The second semiconductor switch 32 is connected firstly to the fourth star point 44 and secondly to the second star point 42. The fifth semiconductor switch 35 is connected firstly to the second star point 42 and secondly to the first star point 41. The sixth semiconductor switch 36 is connected firstly to the first star point 41 and secondly to the fifth star point 45. The first semiconductor switch 31 is connected firstly to the fifth star point 45 and secondly to the third star point 43. The fourth semiconductor switch 34 is connected firstly to the third star point 43 and secondly to the negative potential connection −V_{DC}.

The fifth bidirectional semiconductor switch 35 having a controlled unidirectional current conduction direction can have a first diode 35′. Said first diode can be connected back-to-back in parallel with an IGBT, for example, or can be formed by a diode integrated in a semiconductor switch.

The sixth bidirectional semiconductor switch 36 having a controlled unidirectional current conduction direction can have a second diode 36′. Said second diode can be connected back-to-back in parallel with an IGBT, for example, or can be formed by a diode integrated in a semiconductor switch.

Furthermore, each phase module 24, 26, 28 can have a further energy store 50 between the second star point 42 and the fifth star point 45. Furthermore, the fourth star point 44 is connected to the neutral point connection NP via a seventh bidirectional semiconductor switch 37 having a controlled unidirectional current conduction direction in the direction towards the neutral point connection NP. The neutral point connection NP is connected to the third star point 43 via an eighth bidirectional semiconductor switch 38 having a controlled unidirectional current conduction direction in the direction towards the third start point 43.

Furthermore, the first star point 41 of the phase module 24 for phase u is connected to the associated phase conductor Lu, the first star point 41 of the phase module 26 for phase v is connected to the associated phase conductor Lv, and the first star point 41 of the phase module 28 for phase w is connected to the phase conductor Lw.

As shown in FIGS. 1 and 2, the converter 10 has, in accordance with an exemplary embodiment of the present disclosure, an energy supply 60, which is arranged between the neutral point connection NP and one of the phase conductors Lu, Lv, Lw, for example the phase conductor Lu. A switch 62 is arranged in the connecting conductor between the neutral point connection NP and the energy supply 60, but said switch could also be between the energy supply 60 and the phase conductor Lu. For example, the switch 62 can be formed by a high-voltage relay. In the present example, the energy supply 60 is formed by a transformer which can have three phases on the primary side, said transformer being single-phase on the secondary side. Alternatively, any desired AC voltage source can be used, such as a low-voltage converter, for example. The energy source 60 can be fed, for example, by a low-voltage grid, which can have a voltage of up to 1000 V, and between 380 V and 690 V in accordance with an exemplary embodiment.

As shown in FIG. 1, a known filter 64 can be provided at the output of the inverter 22. On the output side, an electrical load 66, such as an electric machine, is connected to the inverter 22 or, if a filter 64 is present, to the filter 64.

The mentioned bidirectional semiconductor switches having a controlled unidirectional current conduction direction are each formed by an IGBT having a diode back-to-back in parallel. According to another exemplary embodiment disclosed herein, a bidirectional semiconductor switch having a controlled unidirectional current conduction direction can also be designed as follows, for example an IGCT with a diode back-to-back in parallel.

The forward direction of the diodes of the first semiconductor switch 31, the second semiconductor switch 32, the third semiconductor switch 33, the fourth semiconductor switch 34, the fifth semiconductor switch 35 and the sixth semiconductor switch 36 of each phase module 24, 26, 28 is directed in each case towards the positive voltage potential +V_{DC}, the forward direction of the diode of the seventh semiconductor switch 37 is directed towards the fourth star point 44, and the forward direction of diode of the eighth semiconductor switch 38 is directed away from the third star point 43.

The converter 10 according to the present disclosure is operated as follows.

In order to charge the initially discharged first energy store 16 and the initially discharged second energy store 18, in principle only the phase module which is connected directly to the energy supply 60 via the phase conductor is called for. In principle, the energy supply 60 could be connected to the phase conductor Lu, the phase conductor Lv or the phase conductor Lw. According to an exemplary embodiment, the phase conductor Lu and the phase module 24 are selected. Likewise, only the phase module 24 is specified to charge the further energy store 50. The following observations relate merely to the phase module 24 which can have the phase conductor Lu and is connected directly to the energy supply 60, where not mentioned otherwise. The further phase modules 26, 28 are therefore initially optional.

In order to charge the first energy store 16 and the second energy store 18, first all of the semiconductor switches 31, 32, 33, 34, 35, 36, 37, 38 are opened so that no current can flow in the phase module 24. Furthermore, the switch 62 is closed. Therefore, a current can flow from the energy supply 60 via the phase conductor Lu to the first star point 41 and via the fifth semiconductor switch 35, the second semiconductor switch 32 and the third semiconductor switch 33 to the first energy store 16. Furthermore, the current flows through the first energy store 16 back to the energy supply 60, as result of which the first energy store 16 is charged. Furthermore, a current can flow from the energy supply 60 through the second energy store 18, the fourth semiconductor switch 34, the first semiconductor switch 31 and the sixth semiconductor switch 36 to the first star point 41 and from there via the phase conductor Lu back to the energy supply 60, as a result of which the second energy store 18 is charged. As a result, the first energy store 16 and the second energy store 18 can be charged efficiently by means of the energy supply 60 connected between the neutral point connection NP and the phase conductor Lu. It can be advantageous that an AC voltage is present between the neutral point connection NP and the phase conductor Lu owing to the energy supply 60.

Therefore, the diodes contained in the semiconductor switches of the exemplary embodiments described herein are provided such that at least one first diode 35′ is arranged between the phase conductor Lu and the positive potential connection +V_{DC} in such a way that a current can flow from the phase conductor Lu via the first diode 35′ to the positive potential connection +V_{DC}. Furthermore, at least one second diode 36′ should be arranged between the negative potential connection −V_{DC} and the phase conductor Lu in such a way that a current can flow from the negative potential connection −V_{DC} to the phase conductor Lu. The first diode 35′ or the functionality thereof can be provided, for example, by the fifth semiconductor switch 35 and the second diode 36′ or the functionality thereof can be provided, for example, by the sixth semiconductor switch 36. Instead of one diode, it is also possible for a plurality of diodes to be arranged in series with one another and in the same forward direction as one another.

In order to charge the further energy store 50 by means of the energy supply 60, the first semiconductor switch 31 and/or the second semiconductor switch 32 is/are closed. According to an exemplary embodiment of the present disclosure, the first semiconductor switch 31 and/or the second semiconductor switch 32 can be closed before the switch 62 is closed so that, during charging of the first energy store 16, the second energy store 18 and the further energy store 50, the respective voltages increase with one another. As soon as the desired voltage in the further energy store 50 has been reached, the first semiconductor switch 31 and the second semiconductor switch 32 are opened. If desired, which is often the case, the voltage in the first energy store 16 and in the second energy store 18 can be increased further as described above.

If the first semiconductor switch 31 is closed, a current can flow from the energy supply 60 via the first star point 41 to the second star point 42. The current flows from the second star point 42 via the further energy store 50 and the first semiconductor switch 31 to the third star point 43 and back to the energy supply 60 via the neutral point connection NP. A third diode 38′ is arranged between the third star point 43 and the neutral point connection NP, it being possible for said third diode to be realized by the eighth semiconductor switch 38, for example. The forward direction of the third diode 38′ is selected such that the current can flow from the third star point 43 to the neutral point connection NP.

If the second semiconductor switch 32 is closed, a current can flow from the energy supply 60 via the fourth star point 44 and through the closed second semiconductor switch 32 to the second star point 42. Furthermore, the current flows from the second star point 42 via the further energy store 50 to the fifth star point 45 and further via the first star point 41 back to the energy supply 60. A fourth diode 37′ is arranged between the fourth star point 44 and the neutral point connection NP, it being possible for said fourth diode to be realized by the seventh semiconductor switch 37, for example. The forward direction of the fourth diode 37′ is selected such that the current can flow from the neutral point connection NP to the fourth star point 44. Therefore, the further energy store 50 is charged.

The first semiconductor switch 31 and the second semiconductor switch 32 are opened as soon as the further energy store 50 has reached the desired voltage. Furthermore, the switch 62 is opened as soon as the first energy store 16 and the second energy store 18 have reached the desired voltages.

As shown in FIG. 2, the converter can have further phase modules 26, 28 for the phases v, w in addition to the phase module 24 for the phase u, wherein said further phase modules are identical in design to the above-described phase module 24 for the phase u and therefore have further energy stores 50. The further energy stores 50 of the further phase modules 26, 28 are charged at the same time as the further energy store 50 of the phase module 24. The charging operation of the further energy stores 50 of the phase modules 24, 26, 28 takes place simultaneously.

The further energy store 50 of the phase module 26 for phase v is charged as follows.

In order to charge the further energy store 50 of the phase module 26 for phase v, the third semiconductor switch 33, the second semiconductor switch 32, the first semiconductor switch 31 and the fourth semiconductor switch 34 are closed in the phase module 26. As result, a current path is formed in the phase module 26 from the positive potential connection +V_{DC} through the third semiconductor switch 33, the second semiconductor switch 32, the further energy store 50, the first semiconductor switch 31 and the fourth semiconductor switch 34, and the further energy store 50 is charged parallel to the DC link 14. As soon as the further energy store 50 is charged, at least one and, in accordance with an exemplary embodiment, all of the semiconductor switches 31, 32, 33, 34, which were previously closed, are opened again.

If the converter can have further phase modules, such as the phase module 28 for phase w, the further energy store 50 in the (respective) phase module(s) is charged analogously to and simultaneously with the further energy store 50 in the phase module 26 for phase v.

The text which follows describes how charge maintenance of the first energy store 16 and the second energy store 18 of the DC link 14 and of the further energy stores 50 in the phase modules 24, 26, 28 takes place.

The charging of the first energy store 16 and the second energy store 18 of the DC link 14 is often maintained by means of the rectifier 12, but could also be charged or maintained by the energy supply 60, as described above. In turn, it is assumed that all of the semiconductor switches are initially open.

When the switch 62 is open the following semiconductor switches are closed in a first phase module 24′ and a second phase module 26′ of the phase modules 24, 26, 28 of the converter 10. In the first phase module 24′, for example in the phase module 24 for phase u, the third semiconductor switch 33 and the second semiconductor switch 32 are closed, wherein the further semiconductor switches of the first phase module 24′ remain open. In the second phase module 26′, for example in the phase module 26 for phase v, the first semiconductor switch 31 and the fourth semiconductor switch 34 are closed, wherein the further semiconductor switches of the second phase module 26′ remain open. Furthermore, it is assumed below that the phase conductor Lu is connected to the phase conductor Lv, for example via an inductance of an electric machine 66 or else by a suitable current path in a filter 64 provided in any case. As a result, the following current path is formed. The current path leads from the positive potential connection +V_{DC} in the first phase module 24′ via the third semiconductor switch 33 and the second semiconductor switch 32 via the further energy store 50 to the fifth star point 45 and via the second diode 36′ to the phase conductor Lu. The current path leads to the second phase module 26′ via the phase conductor Lu and the phase conductor Lv. In the second phase module 26′, the current path leads from the first star point 41 via the first diode 35′ to the second star point 42 and from there via the further energy store 50, the first semiconductor switch 31 and the fourth semiconductor switch 34 to the negative potential connection −V_{DC}. As a result, owing to the described current path, a current can flow through the further energy store 50 of the first phase module 24′ and through the further energy store 50 of the second phase module 26′, as a result of which said energy stores are charged. As soon as the further energy stores 50 of the first phase module 24′ and the second phase module 26′ have reached the desired voltage, the current path is opened.

Similarly, the further energy stores 50 of the phase module 26 for phase v and the phase module 28 for phase w can also be charged. Likewise, the further energy stores 50 of the phase module 28 for phase w and of the phase module 24 for phase u can be charged.

In a further embodiment of the present disclosure, the rectifier is formed by an active rectifier instead of by the above-described diode rectifier. Said active rectifier has, for example, a phase module for each phase, as is shown in FIG. 3. The phase conductors of the phase modules are connected to the transformer 13 shown in FIG. 1 as well. On the DC voltage side, the phase modules are connected to the DC link 14. The charging operation for charging the further energy stores 50 in the phase modules of the active rectifier takes place similarly to the charging of the further energy store 50 in the phase module 26 for phase v.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 Converter
12 Rectifier
13 Transformer
14 DC link
15 Supply grid
16 First energy store
18 Second energy store
22 Inverter
24 Phase module for phase u
24′ First phase module
26 Phase module for phase v
26′ Second phase module
28 Phase module for phase w
31 First semiconductor switch
32 Second semiconductor switch
33 Third semiconductor switch
34 Fourth semiconductor switch
35 Fifth semiconductor switch
35′ First diode
36 Sixth semiconductor switch
36′ Second diode
37 Seventh semiconductor switch
37′ Fourth diode
38 Eighth semiconductor switch
38′ Third diode
41 First star point
42 Second star point
43 Third star point
44 Fourth star point
45 Fifth star point
50 Further energy store
60 Energy supply
62 Switch
64 Filter
66 Load
+V_{DC} Positive potential connection
−V_{DC} Negative potential connection
NP Neutral point connection
u, v, w Phases
Lu Phase conductor for phase u
Lv Phase conductor for phase v
Lw Phase conductor for phase w

What is claimed is:

1. A converter comprising:
a DC link and at least one phase module, which is electrically connected to the DC link and includes a phase conductor (Lu) emerging from said phase module,
wherein the DC link has a positive potential connection (+V_{DC}), a negative potential connection (−V_{DC}), and a neutral point connection (NP), a first energy store is connected between the positive potential connection (+V_{DC}) and the neutral point connection (NP), and a second energy store is connected between the neutral point connection (NP) and the negative potential connection (−V_{DC}),
wherein the phase conductor (Lu) is connected to the positive potential connection (+V_{DC}) via a first diode and to the negative potential connection (−V_{DC}) via a second diode, and
wherein the converter has an energy supply for charging the first energy store and the second energy store, which energy supply is connected firstly to the neutral point connection (NP) and secondly to the phase conductor (Lu) via a switch.

2. The converter as claimed in claim 1, wherein the energy supply is a transformer, which is single-phase on its secondary side and is connectable to a supply grid on its primary side.

3. The converter as claimed in claim 1, wherein
in a first circuit:
the first energy store is connected in series with the energy supply via the neutral point connection (NP), said energy supply is connected in series with the first diode via the phase conductor (Lu), and said first diode is connected in series with the positive potential connection (+V_{DC}), and
in a second circuit:
the second energy store is connected in series with the second diode via the negative potential connection (−V_{DC}), and said second diode is connected in series with the energy supply via the phase conductor (Lu).

4. The converter as claimed in claim 1, wherein the first diode is formed by a bidirectional semiconductor switch having a controlled unidirectional current conduction direction, and/or the second diode is formed by a bidirectional semiconductor switch having a controlled unidirectional current conduction direction.

5. The converter as claimed in claim 1, wherein the at least one phase module has a further energy store, which is assigned to the phase module and is connected firstly to the neutral point connection (NP) via a second bidirectional semiconductor switch having a controlled unidirectional current conduction direction and to the phase conductor (Lu) via the first diode and is connected secondly to the neutral point connection (NP) via a first bidirectional semiconductor switch having a controlled unidirectional current conduction direction and is connected to the phase conductor (Lu) via the second diode.

6. The converter as claimed in claim 5, wherein the further energy store, which is assigned to the phase module, in a third circuit is connected in series with the first bidirectional semiconductor switch, the energy supply, and the first diode, and, in a fourth circuit, the further energy store is connected in series with the second diode, the energy supply, and the second bidirectional semiconductor switch.

7. A method for operating a converter as claimed in claim 1, including a DC link and a phase module, which is electrically connected to the DC link and includes a phase conductor (Lu) emerging from said phase module, wherein the DC link has at least a positive potential connection (+V_{DC}), a negative potential connection (−V_{DC}), and a neutral point connection (NP); a first energy store between the positive potential connection (+V_{DC}) and the neutral point connection (NP); and a second energy store between the neutral point connection (NP) and the negative potential connection (−V_{DC}), wherein the phase conductor (Lu) is connected to the positive potential connection (+V_{DC}) via a first diode and to the negative potential connection (−V_{DC}) via a second diode, wherein an energy supply is connectable firstly to the neutral point connection (NP) and secondly to the phase conductor (Lu) via a switch, the method comprising:
applying an AC voltage to the energy supply;
closing the switch;
charging the first energy store with a first half-cycle of current of the energy supply; and
charging the second energy store with a second half-cycle of the current of the energy supply.

8. The method as claimed in claim 7, wherein the phase module has a further energy store, which is associated with the phase module, the further energy store is connected firstly to the phase conductor (Lu) via the first diode and to the neutral point connection (NP) via a second semiconductor switch having a controlled unidirectional current conduction direction, and is connected secondly to the phase conductor (Lu) via the second diode and to the neutral point connection (NP) via a first semiconductor switch having a controlled unidirectional current conduction direction, the method comprising:
closing at least one of the first semiconductor switch and the second semiconductor switch; and
charging the further energy store associated with the phase module by means of the energy supply.

9. The method as claimed in claim 8, wherein the charging of the further energy store associated with the phase module takes place parallel to the charging of the first energy store and the second energy store.

10. The method as claimed in claim 8, comprising:
closing the first semiconductor switch and the second semiconductor switch; and
charging the further energy store associated with the phase module by means of the positive and negative half-cycles of the energy supply.

11. The method as claimed in claim 7, wherein the at least one phase module is a first phase module, and the converter has a second phase module, wherein the second phase module has a further energy store, which is associated with the second phase module and which is connected firstly to a further phase conductor (Lv) via a first diode of the second phase module and to the positive potential connection (+V_{DC}) via a second semiconductor switch having a controlled unidirectional current conduction direction of the second phase module and is connected secondly to the further phase conductor (Lv) via a second diode of the second phase module and to the negative potential connection (−V_{DC}) via a first semiconductor switch having a controlled unidirectional current conduction direction of the second phase module, the method comprising:
closing the first semiconductor switch of the second phase module and the second semiconductor switch of the second phase module;
charging the further energy store associated with the second phase module.

12. The method as claimed in claim 11, wherein the charging of the further energy store associated with the second phase module takes place parallel to the charging of the first energy store and the second energy store.

13. The method as claimed in claim 11, comprising:
connecting the first phase conductor (Lu) to the second phase conductor (Lv, Lw);
opening the first semiconductor switch of the first phase module;
opening the second semiconductor switch of the second phase module;
closing the second semiconductor switch of the first phase module;
closing the first semiconductor switch of the second phase module; and
charging the further energy store of the first phase module and the further energy store of the second phase module.

14. The method as claimed in claim 13, comprising:
connecting the first phase conductor (Lu) to the second phase conductor (Lv) via induction.
